(19) United States
(12) Patent Application Publication
(10) Pub. No.: US 2026/0245757 A1
(43) Pub. Date: Aug. 20, 2026

(54) Composite Materials for Radiation Shielding, Articles, and Methods

(71) Applicant: The Florida State University Research Foundation, Inc., Tallahassee, FL (US)

(72) Inventor: Zhibin Yu, Tallahassee, FL (US)

(21) Appl. No.: 19/647,678

(22) Filed: Apr. 14, 2026

Related U.S. Application Data
(62) Division of application No. 18/059,729, filed on Nov. 29, 2022.
(60) Provisional application No. 63/284,391, filed on Nov. 30, 2021.

(51) Int. Cl. G21F 1/10; A41D 13/05; A41D 31/04; C08J 3/21; C08J 5/18; C08K 3/22; G21F 3/02

(52) U.S. Cl. CPC G21F 1/103; A41D 13/05; A41D 31/04; C08J 3/212; C08J 5/18; C08K 3/22; G21F 3/02; C08J 2353/02

(57) ABSTRACT

Composite materials that may include particles of an inorganic material and an elastic polymer. The composite materials may be in the form of a flexible film. The composite materials may provide radiation shielding. Articles on or in which a composite material is disposed. Methods of forming composite materials.

### CROSS-REFERENCE TO RELATED APPLICATIONS

This application is a divisional of U.S. patent application Ser. No. 18/059,729, filed Nov. 29, 2022, which claims priority to U.S. Provisional Patent Application No. 63/284,391, filed Nov. 30, 2021. The content of these applications is incorporated by reference herein.

### STATEMENT REGARDING FEDERALLY SPONSORED RESEARCH OR DEVELOPMENT

This invention was made with government support under Contract No. FA9550-16-1-0124 awarded by the Air Force Office of Scientific Research. The government has certain rights in this invention.

### BACKGROUND

Many technologies, such as medical imaging, can expose users and patients to radiation. Various protective equipment can be used to protect users and patients, such as lead aprons. Lead (Pb), however, can be disadvantageous for a number of reasons, including, for example, its toxicity, weight, rigidness, etc.

Numerous materials other than lead have been tested and used for radiation protection. Radiation protection materials have been used in articles of clothing, such as gloves, but such materials typically include relatively low concentrations of particles, such as concentrations of up to 80%, by weight, of embedded particles. Greater concentrations have not been used, because doing so makes it difficult, if not impossible, to control the locations of the particles, and/or maintain suitable physical properties of the materials.

There remains a need for composite materials that may be capable of providing protection from radiation, including materials that may be flexible, may provide relatively high radiation attenuation, and/or can maintain one or more desirable physical properties at relatively high particle concentrations, such as a desired degree of flexibility, durability, etc.

### BRIEF SUMMARY

Provided herein are composite materials, embodiments of which can achieve high radiation attenuation without undesirably impacting one or more physical properties of the composite materials, such as mechanical flexibility, durability, etc. Also provided are methods of making composite materials and articles, and methods for improving the radiation attenuation of articles.

In one aspect, composite materials are provided. In some embodiments, the composite materials include particles of an inorganic material, and an elastic polymer in which the particles of the inorganic material are dispersed. The particles of the inorganic material may be present at an amount of at least 80%, by weight, based on the total weight of the particles of the inorganic material and the elastic polymer. The inorganic material may be a metal oxide, such as bismuth (III) oxide (Bi₂O₃). The elastic polymer may be a block copolymer, such as a block copolymer that includes at least one styrene block and at least one polyalkene block.

In another aspect, articles are provided. In some embodiments, a composite material provided herein is disposed on or in the article. The article may include an article of clothing.

In a further aspect, methods of improving radiation attenuation are provided. In some embodiments, the methods include providing an article having a surface or an inner space, and disposing a composite material as described herein on the surface or in the inner space of the article.

In a still further aspect, methods of forming composite materials are provided. In some embodiments, the methods include contacting particles of an inorganic material and an elastic polymer in a liquid, and removing at least a portion of the liquid to form the composite material. A weight ratio of the particles of the inorganic material to the elastic polymer may be about 4:1 to about 20:1.

Additional aspects will be set forth in part in the description which follows, and in part will be obvious from the description, or may be learned by practice of the aspects described herein. The advantages described herein may be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1A depicts an embodiment of an article in which an embodiment of a composite material is disposed.

FIG. 1B depicts a cross-sectional view of the article of FIG. 1B.

FIG. 2A depicts an embodiment of an article in which an embodiment of a composite material is disposed.

FIG. 2B depicts a cross-sectional view of the article of FIG. 2B.

### DETAILED DESCRIPTION

Provided herein are composite materials that may be flexible, and/or include relatively high particle loadings. The composite materials, therefore, may be flexible, and/or have very high attenuation properties per unit thickness and/or per unit weight.

### Composite Materials

In one aspect, composite materials are provided. The composite materials may include particles of an inorganic material, and an elastic polymer in which the particles of the inorganic material are dispersed.

The particles of the inorganic material may be dispersed evenly or unevenly in the elastic polymer. When the particles of the inorganic material are unevenly dispersed in the elastic polymer, the particles of the inorganic material may be present at a gradient. The gradient may be configured to provide an increased concentration of the particles of the inorganic material at a desired area of the composite material, such as an area that may (i) face a greater risk of radiation exposure, (ii) be exposed to a greater dose of radiation, and/or (iii) shield an object/person or portion thereof having increased sensitivity to radiation.

The particles of an inorganic material may be present in the composite materials at any amount. In some embodiments, the particles of the inorganic material are present at an amount of at least 80%, by weight, based on the total weight of the particles of the inorganic material and the elastic polymer. In some embodiments, the particles of the inorganic material are present at an amount of at least 85%, by weight, based on the total weight of the particles of the inorganic material and the elastic polymer. In some embodiments, the particles of the inorganic material are present at an amount of at least 90%, by weight, based on the total weight of the particles of the inorganic material and the elastic polymer. In some embodiments, the particles of the inorganic material are present at an amount of at least 95%, by weight, based on the total weight of the particles of the inorganic material and the elastic polymer.

The composite materials may be in any form. In some embodiments, the composite material is in the form of a film, such as a flexible film. As used herein, the phase “flexible film” refers to a film that can be bent, curved, rolled, etc., without breaking.

When the composite materials described herein are in the form of a film, the film may have any size and/or thickness. In some embodiments, the film has a thickness of about 0.1 mm to about 3 mm, about 0.1 mm to about 2 mm, about 0.1 mm to about 1 mm, or about 0.1 mm to about 0.5 mm. The size of the composite material may correspond to an article on and/or in which the composite material is disposed.

When the composite materials are in the form of a film, the composite materials may consist of a single film. In some embodiments, the composite materials may include two or more films arranged on and in contact with each other. When the composite materials include two or more films, the two or more films may include the same or different inorganic material(s) and/or the same or different elastic polymer(s).

In some embodiments, the composite material has a lead equivalency of about 0.09 to about 0.29 at 60 kVp, 70 kVp, 80 kVp, 90 kVp, 100 kVp, or 110 kVp. In some embodiments, the composite material has a lead equivalency of about 0.09 to about 0.29 at 60 kVp, 70 kVp, 80 kVp, or 90 kVp. In some embodiments, the composite material has a lead equivalency of about 0.09 to about 0.28 at 100 kVp or 110 kVp.

### Inorganic Particles

The composite materials provided herein may include inorganic particles, which are particles formed at least in part of an inorganic material. The inorganic material may be any material that is capable of attenuating radiation. The inorganic material may be a metal oxide. A metal cation of the metal oxide may include a post-transition metal, such as a pcnictogen. In some embodiments, the inorganic particles include bismuth (III) oxide (Bi₂O₃).

The particles generally may be of any size. The particles may be of a size that is substantially uniform. The particles may have a range of different sizes. In some embodiments, the particles are nanoparticles having an average particle size of about 1 nm to about 900 nm, or about 50 nm to about 500 nm. In some embodiments, the particles are in the form of a powder, which may have an average particle size of about 0.3 μm to about 2 mm. In some embodiments, the inorganic particles have a particle size of about 50 nm to about 2 mm, about 50 nm to about 1 mm, about 50 nm to about 0.5 mm, about 50 nm to about 0.1 mm, about 50 nm to about 0.01 mm, about 50 nm to about 1 μm, about 50 nm to about 0.5 μm, about 50 nm to about 400 nm, about 50 nm to about 300 nm, or about 80 nm to about 250 nm. The average particle size is determined by laser diffraction when the average particle size is greater than 10 nm, and dynamic light scattering when the average particle size is 10 nm or less.

The particles generally may be of any shape. For example, the particles may be substantially spherical, irregularly-shaped, etc.

### Polymers

The composite materials described herein may include any polymer, such as an elastic polymer (i.e., elastomer). As used herein, the term “polymer” includes any material formed of two or more monomers of one or more types covalently bonded together, including, but not limited to, homopolymers, oligomers, copolymers (e.g., block copolymers), terpolymers, etc. of any known configuration, e.g., linear, star, comb, crosslinked, etc. As used herein, the phrase “elastic polymer” and the term “elastomer” refer to polymers that are capable of returning to their original length and/or shape after stretching, deformation, compression, expansion, or a combination thereof.

In some embodiments, the elastic polymer is a copolymer, such as a block copolymer. In some embodiments, the block copolymer is a tri-block copolymer having a structure comprising the following formula:

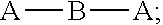

wherein A is an organic polymer including an aryl side chain, and B is a polyalkene.

The organic polymer may include an unsubstituted or substituted phenyl side chain. For example, the organic polymer may include polystyrene or a substituted derivative thereof (e.g., poly-4-methylstyrene).

The polyalkene may be any of those known in the art, including a polyalkene that is substituted. The polyalkene may be substituted with an alkyl or alkene side chain, such as a C₁-C₅ alkyl/alkene sidechain. In some embodiments, the polyalkene is polyisoprene. The polyisoprene may include any one or more of the isomers of polyisoprene.

Unless otherwise indicated, the term “substituted,” when used to describe a chemical structure or moiety, refers to a derivative of that structure or moiety wherein (i) a multi-valent non-carbon atom (e.g., oxygen, nitrogen, sulfur, phosphorus, etc.) is bonded to one or more carbon atoms of the chemical structure or moiety (e.g., a “substituted” C₄ hydrocarbyl may include, but is not limited to, diethyl ether moiety, a methyl propionate moiety, an N,N-dimethylacetamide moiety, a butoxy moiety, etc.) or (ii) one or more of its hydrogen atoms (e.g., chlorobenzene may be characterized generally as an aryl C₆ hydrocarbyl “substituted” with a chlorine atom) is substituted with a chemical moiety or functional group such as alcohol, alkoxy, alkanoyloxy, alkoxycarbonyl, alkenyl, alkyl (e.g., methyl, ethyl, propyl, t-butyl), alkynyl, alkylcarbonyloxy (—OC(O)alkyl), amide (—C(O)NH-alkyl- or -alkylNHC(O)alkyl), tertiary amine (such as alkylamino, arylamino, arylalkylamino), aryl, aryloxy, azo, carbamoyl (—NHC(O)O-alkyl- or —OC(O)NH-alkyl), carbamyl (e.g., CONH₂, as well as CONH-alkyl, CONH-aryl, and CONH-arylalkyl), carboxyl, carboxylic acid, cyano, ester, ether (e.g., methoxy, ethoxy), halo, haloalkyl (e.g., —CCl₃, —CF₃, —C(CF₃)₃), heteroalkyl, isocyanate, isothiocyanate, nitrile, nitro, oxo, phosphodiester, sulfide, sulfonamido (e.g., SO₂NH₂), sulfone, sulfonyl (including alkylsulfonyl, arylsulfonyl and arylalkylsulfonyl), sulfoxide, thiol (e.g., sulfhydryl, thioether) or urea (—NHCONH-alkyl-).

### Articles

In another aspect, articles are provided. The articles may include a composite material described herein disposed on or in the article. The composite material optionally may be affixed to the article in any manner using any technique or material, including, but not limited to, stitching, an adhesive, friction, etc. In some embodiments, the articles are formed, in whole or in part, of a composite material described herein.

The article may be an article of clothing (e.g., shirt, hat, gloves, socks, shoes, pants, apron, bib, etc.) or other manufacture, such as a protective accessory (e.g., helmet, face shield, glasses, etc.), a protective barrier, a vehicle or part thereof, any apparatus or part thereof (e.g., a medical imaging instrument), or any system or part thereof (e.g., a weapon system) that may be exposed to radiation.

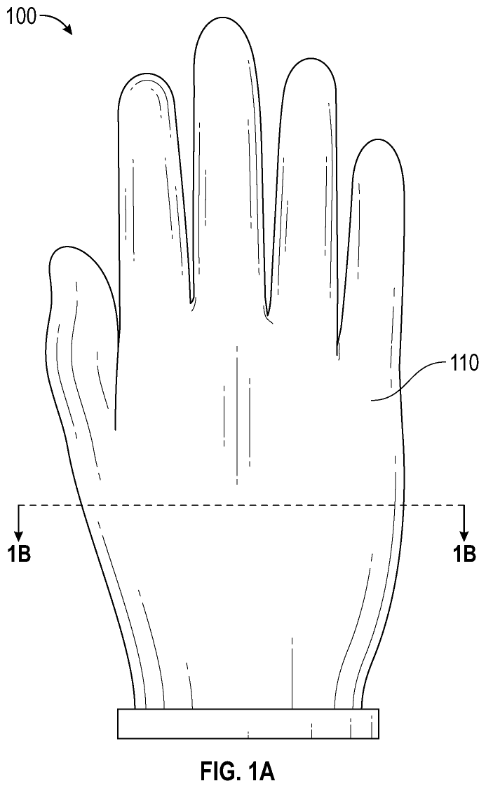

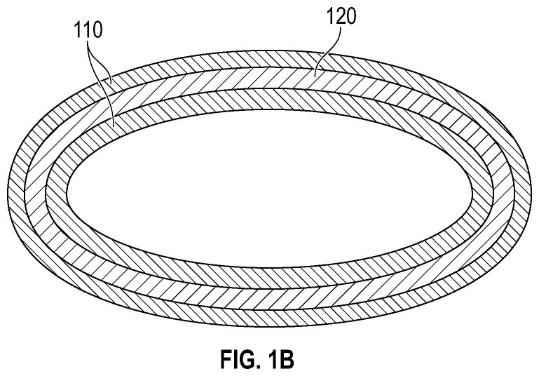

If, for example, the article is a glove, the composite material may be disposed on an external surface of the glove, on an internal surface of the glove, in an inner space of the glove (e.g., a space between fabrics of which the glove is formed) (see FIG. 1A and FIG. 1B), or a combination thereof.

FIG. 1A and FIG. 1B depict an embodiment of a glove 100 that includes a composite material 120 disposed in the glove 100. The glove 100 is formed of two layers of a fabric material 110 (e.g., polyester, cotton, etc.), and between these layers of fabric material 110, a film of a composite material 120 is disposed. Although a single film of the composite material 120 is depicted at FIG. 1A and FIG. 1B, other embodiments are envisioned, including embodiments in which two or more films of the composite material 120 are disposed between the layers of the fabric material 110.

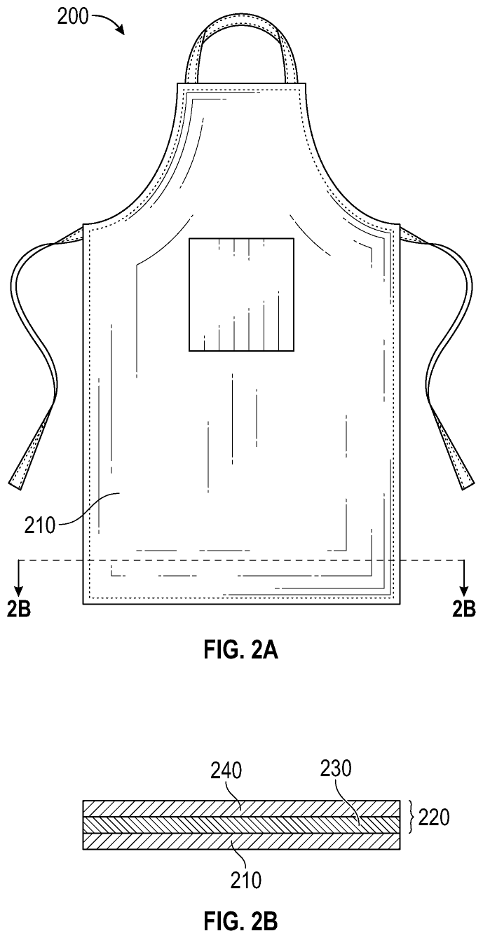

FIG. 2A and FIG. 2B depict an embodiment of an apron 200 that includes a composite material 220 disposed on a surface of the fabric 210 from which the apron 200 is made. The apron 200 is formed of fabric material 210, and a composite material 220 including a first film 230 and a second film 240 is disposed on the fabric 210. Although not depicted at FIG. 2B, in some embodiments, the apron 200 includes a second layer of fabric 210 arranged on and in contact with the second film 230, thereby placing the composite material 220 between two layers of fabric 210.

### Methods

In another aspect, methods of forming composite materials are provided. In some embodiments, the methods include contacting particles of an inorganic material and an elastic polymer in a liquid; and removing at least a portion of the liquid to form the composite material.

The liquid may be a non-solvent or a solvent, such as a solvent for the elastic polymer. In some embodiments, the liquid is an organic liquid. The organic liquid may be an aromatic liquid. The organic liquid may be a non-polar aromatic liquid. In some embodiments, the organic liquid includes toluene.

The removing of the at least a portion of the liquid may be achieved using any known technique(s). In some embodiments, the removing of the liquid includes evaporating the liquid. The evaporating of the liquid may occur at a temperature greater than room temperature, a pressure less than atmospheric pressure, or a combination thereof.

In some embodiments, the methods include contacting the particles of the inorganic material with a surface modifying agent. The particles of the inorganic material and the surface modifying agent may be contacted before the particles of the inorganic material and the elastic polymer are contacted in a liquid. The surface modifying agent may be removed, at least partially, by rinsing the particles of the inorganic material, via filtration, or a combination thereof. Other known techniques may be used.

In some embodiments, the methods also include extruding the composite material; and injecting the composite material into a mold. After the injecting, the composite material may be cooled, and removed from the mold. The mold may impart any shape to the composite material, but, in some embodiments, the mold forms a film-shaped composite material.

In another aspect, methods of improving an article's radiation attenuation are provided. In some embodiments, the methods include providing an article having a surface or inner space; and disposing a composite material described herein on the surface or in the inner space. The composite material disposed on or in the article may be a single-layer composite material, or a composition material that includes two or more layers. As explained herein, the composite material may be affixed to the article in any manner using any technique or material, including, but not limited to, stitching, an adhesive, friction, etc.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

In the descriptions provided herein, the terms “includes,” “is,” “containing,” “having,” and “comprises” are used in an open-ended fashion, and thus should be interpreted to mean “including, but not limited to.” When composite materials, articles, and methods are claimed or described in terms of “comprising” various steps or components, the composite materials, articles, and methods can also “consist essentially of” or “consist of” the various steps or components, unless stated otherwise.

The terms “a,” “an,” and “the” are intended to include plural alternatives, e.g., at least one. For instance, the disclosure of “a tri-block copolymer”, “an inorganic material”, and the like, is meant to encompass one, or mixtures or combinations of more than one tri-block copolymer, inorganic material, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in some embodiments, that the film has a thickness of about 0.1 mm to about 1 mm. This range should be interpreted as encompassing about 0.1 mm and about 1 mm, and further encompasses “about” each of 0.2 mm, 0.3 mm, 0.4 mm, 0.5 mm, 0.6 mm, 0.7 mm, 0.8 mm, and 0.9 mm, including any ranges and sub-ranges between any of these values.

As used herein, the term “about” means plus or minus 10% of the numerical value of the number with which it is being used.

### EXAMPLES

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### Example 1—Preparing of Embodiments of Composite Materials

In this example, embodiments of composite materials were prepared, including embodiments that featured very high loading concentrations of inorganic particles in an elastic polymer. Embodiments of the composite materials of this example were capable of achieving high radiation attenuation, without undesirably impacting mechanical flexibility of the composite materials.

In this example, a commercially available powder of bismuth oxide (Bi₂O₃) (99.9% purity) was used. 28 g of the bismuth oxide power was contacted with a surface modification agent (0.1 g) in toluene. The bismuth oxide was then filtered and dried.

An elastic tri-block copolymer was used in this example. The elastic tri-block copolymer was polystyrene-isoprene-styrene, and 6 g of this copolymer was dissolved in 50 mL toluene.

The toluene/copolymer solution was then mixed with the bismuth oxide powder. The toluene was then separated via evaporation, and the resulting bismuth oxide/copolymer material was subjected to hot extrusion, injection into a mold, and cool down to produce the composite material.

Four samples of the composite material of this example were prepared, and each sample was a flexible film (10 cm×10 cm).

### Example 2—Testing of Composite Materials

The four samples of Example 1 were tested to determine their lead equivalency (mm Pb). A monolayer of each sample was tested, and the results are provided at the following table:

| | No. of | Lead Equivalency (mm Pb) | | | | | |
|---|---|---|---|---|---|---|---|
| Sample No. | Layers | 60 kVp | 70 kVp | 80 kVp | 90 kVp | 100 kVp | 110 kVP |
| 1 | 1 | 0.09 | 0.09 | 0.09 | 0.09 | 0.09 | 0.09 |
| 2 | 1 | 0.09 | 0.09 | 0.10 | 0.10 | 0.10 | 0.10 |
| 3 | 1 | 0.09 | 0.09 | 0.09 | 0.09 | 0.09 | 0.09 |
| 4 | 1 | 0.29 | 0.29 | 0.29 | 0.29 | 0.28 | 0.28 |

In addition to achieving the results of the foregoing table, each of the samples was flexible.

1. A method of forming a composite material, the method comprising:
contacting particles of an inorganic material and an elastic polymer in a liquid, wherein a weight ratio of the particles of the inorganic material to the elastic polymer is about 4:1 to about 20:1; and
removing at least a portion of the liquid to form the composite material.

2. The method of claim 1, wherein the inorganic material is a metal oxide.

3. The method of claim 2, wherein the metal oxide is bismuth (III) oxide (Bi₂O₃).

4. The method of claim 1, wherein the elastic polymer is a block copolymer.

5. The method of claim 4, wherein the block copolymer is a tri-block copolymer having a structure comprising the following formula: 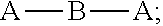
wherein A is an organic polymer comprising an aryl side chain, and B is a polyalkene.

6. The method of claim 5, wherein (i) the organic polymer comprises polystyrene, (ii) the polyalkene comprises polyisoprene, or (iii) the organic polymer comprises polystyrene, and the polyalkene comprises polyisoprene.

7. The method of claim 1, further comprising:
contacting the particles of the inorganic material with at least one surface-modifying agent prior to the contacting of the particles of the inorganic material with the elastic polymer.

8. The method of claim 1, further comprising:
extruding the composite material; and
injecting the composite material into a mold.

9. The method of claim 1, wherein the liquid is a solvent for the elastic polymer.

10. The method of claim 1, wherein the liquid comprises an organic liquid.

11. The method of claim 10, wherein the organic liquid comprises an aromatic organic liquid.

12. The method of claim 11, wherein the aromatic organic liquid comprises toluene.

13. A method of forming a composite material, the method comprising:
contacting particles of an inorganic material and an elastic polymer in a liquid, wherein a weight ratio of the particles of the inorganic material to the elastic polymer is about 4:1 to about 20:1; and
removing at least a portion of the liquid to form the composite material;
wherein the inorganic material comprises a metal oxide, and
wherein the elastic polymer comprises a tri-block copolymer having a structure comprising the following formula— 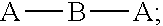
wherein A comprises an organic polymer comprising an aryl side chain, and B comprises a polyalkene.

14. A method of improving radiation attenuation, the method comprising:
providing an article having a surface or an inner space; and
disposing a composite material on the surface or in the inner space of the article;
wherein the composite material comprises—
particles of an inorganic material, and
an elastic polymer in which the particles of the inorganic material are dispersed,
wherein the particles of the inorganic material are present at an amount of at least 80%, by weight, based on the total weight of the particles of the inorganic material and the elastic polymer.

15. The method of claim 14, wherein the inorganic material is a metal oxide.

16. The method of claim 15, wherein the metal oxide is bismuth (III) oxide (Bi₂O₃).

17. The method of claim 14, wherein the elastic polymer is a block copolymer.

18. The method of claim 17, wherein the block copolymer is a tri-block copolymer having a structure comprising the following formula: 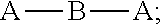
wherein A is an organic polymer comprising an aryl side chain, and B is a polyalkene.
